(19) United States
(12) Patent Application Publication
(10) Pub. No.: US 2011/0060459 A1
(43) Pub. Date: Mar. 10, 2011

(54) ROBOT AND METHOD OF CONTROLLING THE SAME

(75) Inventors: Tae Sin HA, Seoul (KR); Woo Sup HAN, Yongin-si (KR)

(73) Assignee: SAMSUNG ELECTRONICS, CO., LTD., Suwon-si (KR)

(21) Appl. No.: 12/875,750

(22) Filed: Sep. 3, 2010

(30) Foreign Application Priority Data
Sep. 7, 2009 (KR) 10-2009-84012

(51) Int. Cl. B25J 9/00; G06N 5/04

(52) U.S. Cl. 700/246; 901/50

(57) ABSTRACT

Disclosed are a robot deciding a robot's task operation by separating raw information from specific information and a method of controlling the robot. The robot includes an information separation unit to separate raw information and specific information, an operation decision unit to decide a task operation of a robot by inferring a circumstance, a user's intention, task content, and detailed task information from the separated information, and a behavior execution unit to operate the robot in response to the decided task operation of the robot.

### CROSS-REFERENCE TO RELATED APPLICATIONS

This application claims the benefit of Korean Patent Application No. 2009-84012, filed on Sep. 7, 2009 in the Korean Intellectual Property Office, the disclosure of which is incorporated herein by reference.

### BACKGROUND

1. Field

Example embodiments relate to a robot determining a task operation using both input information acquired from a user command and other input information acquired from a sensor, and a method of controlling the robot.

2. Description of the Related Art

The Minerva robot which was deployed in a museum after having been developed at Carnegie Mellon University (CMU) includes a total of four layers, i.e., a high-level control and learning layer, a human interface layer, a navigation layer, and a hardware interface layer. The Minerva robot scheme is based on a hybrid approach, including collecting modules related to human interface and navigation functions, and designing the collected modules in the form of an individual control layer in a different way from other structures. The Minerva robot structure is divided into four layers, which respectively take charge of planning, intelligence, behavior and the like, so that the functions of respective layers may be extended and the independency for each team may be supported.

Care-O-bot, developed by the Fraunhofer Institute for Manufacturing Engineering and Automation (IPA) in Germany, includes a hybrid control structure and a real-time frame structure. The hybrid control structure is able to control a variety of application operations and is also able to cope with abnormal conditions. In addition, there is a high possibility that the real-time frame structure is applied to a different kind of structure by applying an abstract concept to an operating system (OS). Specifically, the real-time frame structure is able to use all operating systems (OSs) that support the Portable Operating System Interface Application Programming Interface (POSIX API), so that the real-time operating system (OS) such as VxWorks can be utilized.

The Royal Institute of Technology Library in Sweden has proposed Behavior-based Robot Research Architecture (BERRA) for reusability and flexibility of a mobile service robot. The BERRA includes three layers, i.e., a deliberate layer, a task execution layer, and a reactive layer. The BERRA separates a layer in charge of a planning function and the other layer in charge of a service function from each other, so that it is possible to generate plans of various combinations.

Tripodal Schematic Control Architecture, that has been proposed by KIST and applied to a service robot ‘Personal Service Robot’, includes a typical three-layer architecture, and it is able to provide a variety of combined services by separating a planning function and a service function from each other. In addition, the Tripodal Schematic Control Architecture provides independency for implementation for each team, so that it is easily able to support a large-scale robot project.

### SUMMARY

Therefore, it is an aspect of example embodiments to provide a robot deciding a task operation appropriate for a peripheral circumstance by referring to both input information acquired from a user command and other input information acquired from a sensor, and a method of controlling the robot.

It is another aspect of the example embodiments to provide a robot for deciding a task operation by inferring a circumstance, user's intention, task content, and detailed task information, and a method of controlling the robot.

The foregoing and/or other aspects are achieved by providing a robot including an information separation unit to separate raw information and specific information, and an operation decision unit to decide a task operation of a robot by inferring a circumstance, a user's intention, task content, and detailed task information from the separated information.

The operation decision unit may receive the raw information, and convert the received raw information into data recognizable by the robot.

The operation decision unit may receive the specific information, and convert the received specific information into data recognizable by the robot.

The operation decision unit may include a circumstance inference unit which firstly infers the circumstance from the raw information and a circumstance, a user's intention, task content, and detailed task information of a time point earlier than that of the circumstance inference.

The circumstance inference unit may compare the firstly-inferred circumstance information with the specific information, and thus secondly infer the circumstance.

The operation decision unit may include an intention inference unit which firstly infers the user's intention from the raw information and the inferred circumstance information.

The intention inference unit may secondly infer the user's intention by comparing the firstly-inferred user's intention information with the specific information.

The operation decision unit may include a task inference unit which firstly infers the task content from the raw information and the inferred intention information.

The task inference unit may secondly infer the task content by comparing the firstly-inferred task content information with the specific information.

The operation decision unit may include a detailed information inference unit which firstly infers the detailed task information from the raw information and the inferred task content information.

The detailed information inference unit may secondly infer the detailed task information by comparing the inferred detailed information with the specific information.

The robot may further include a behavior execution unit to operate the robot in response to the decided task operation of the robot.

The foregoing and/or other aspects are achieved by providing a method of controlling a robot including separating raw information and specific information, and deciding a task operation of a robot by inferring a circumstance, a user's intention, task content, and detailed task information from the separated information.

The deciding of the task operation of the robot may include deciding the robot's task operation by inferring the circumstance from the raw information and a circumstance, a user's intention, task content, and detailed task information of a time point earlier than that of the circumstance inference.

The method may further include re-inferring the circumstance by comparing the inferred circumstance information with the specific information.

The deciding of the task operation of the robot may include deciding the robot task operation by inferring the user's intention from the inferred circumstance information and the raw information.

The method may further include re-inferring the user's intention by comparing the inferred user's intention information with the specific information.

The deciding of the task operation of the robot may include deciding the robot task operation by inferring the task content from the inferred user's intention information and the raw information.

The method may further include re-inferring the task content by comparing the inferred task content information with the specific information.

The deciding of the task operation of the robot may include deciding the robot task operation by inferring the detailed task information from the inferred task content information and the raw information.

The method may further include re-inferring the detailed task information by comparing the inferred detailed task information with the specific information.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram illustrating the relationship between a robot behavior decision model and a user according to example embodiments.

FIG. 2 is a block diagram illustrating a robot behavior decision model according to example embodiments.

FIG. 3 depicts a scenario for a robot behavior decision model according to example embodiments.

FIG. 4 is a flowchart illustrating a robot behavior decision model according to example embodiments.

### DETAILED DESCRIPTION

Reference will now be made in detail to example embodiments, examples of which are illustrated in the accompanying drawings, wherein like reference numerals refer to like elements throughout.

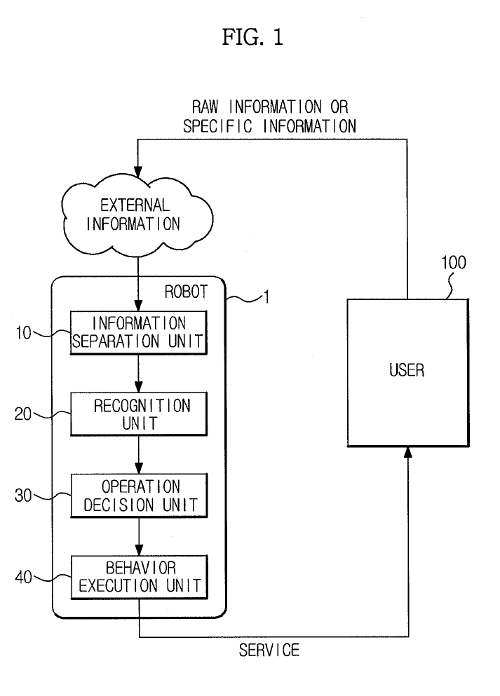

FIG. 1 is a block diagram illustrating the relationship between a robot behavior decision model and a user according to example embodiments.

As shown in FIG. 1, the behavior decision model of a robot 1 includes an information separation unit 10 to separate raw information and specific information from each other, a recognition unit 20 to convert the separated information into data recognizable by the robot 1, an operation decision unit 30 to determine a task operation of the robot 1 by combination of the separated and recognized information, and a behavior execution unit 40 to operate the robot 1.

The information separation unit 10 separates raw information entered via an active sensing unit such as a sensor, and specific information entered via a passive sensing unit such as a user interface from each other. Information entered via the active sensing unit has an indistinct object, and is unable to clearly reflect the object or intention desired by the user 100. In contrast, information entered via the passive sensing unit has a distinct object, and the user's intention is reflected in this information without any change.

The recognition unit 20 receives raw information entered via the active sensing unit, and converts the received raw information into data recognizable by the robot 1. In addition, the recognition unit 20 receives specific information entered via the passive sensing unit, and converts the received specific information into data recognizable by the robot 1.

The operation decision unit 30 may include a plurality of inference units 32, 34, 36, and 38 which respectively output the inference results to different categories (circumstance, user's intention, task content, and detailed task information). The operation decision unit 30 determines a task operation that needs to be performed by the robot 1 in response to the inferred circumstance, user's intention, task operation, or detailed task information.

The behavior execution unit 40 operates the robot 1 in response to the task operation determined by the operation decision unit 30, and provides the user 100 with a service.

Meanwhile, the user 100 transmits requirements to the robot 1, and receives a service corresponding to the requirements.

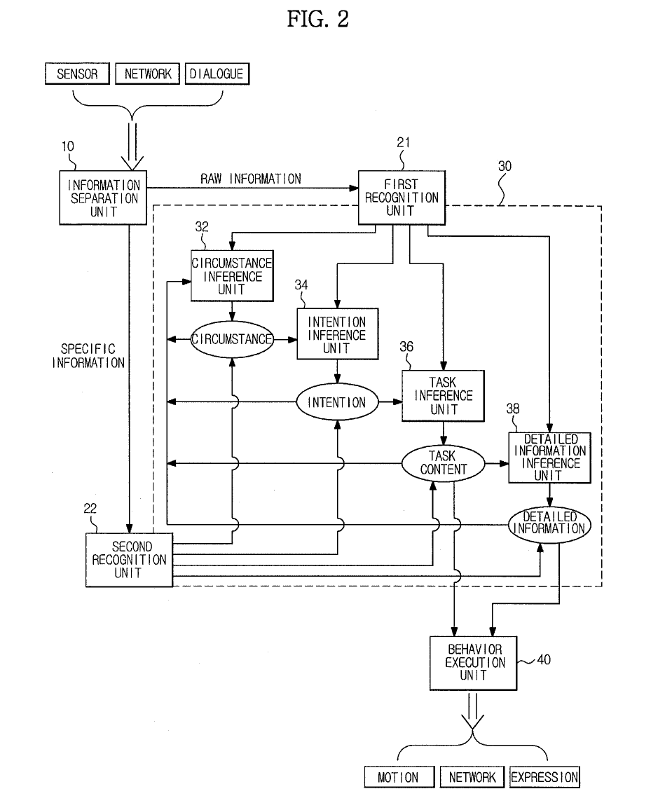

FIG. 2 is a block diagram illustrating a robot behavior decision model according to example embodiments.

Referring to FIG. 2, the robot 1 includes an information separation unit 10 to perform separation of external input information according to a method of entering the external input information, first and second recognition units 21 and 22 to receive the separated information and convert the received information into data recognizable by the robot 1, an operation decision unit 30 to determine a task operation by combination of the separated and converted information, and a behavior execution unit 40 to operate the robot 1 according to the determined task operation.

The information separation unit 10 separates raw information entered via an active sensing unit and specific information entered via a passive sensing unit from each other.

The first recognition unit 21 receives raw information entered via the active sensing unit, and converts the received raw information into data recognizable by the robot 1. The second recognition unit 22 receives specific information entered via the passive sensing unit, and converts the received specific information into data recognizable by the robot 1. The first recognition unit 21 converts raw information into other data, and transmits the other data to all of a circumstance interference unit 32, an intention inference unit 34, a task inference unit 36, and a detailed information inference unit 38. The second recognition unit 22 converts specific information into other data, and transmits the other data to one or more of the inference units 32, 34, 36, or 38 related to the specific information. For example, raw information indicating temperature/humidity—associated information is transmitted to all of the circumstance interference unit 32, the intention inference unit 34, the task inference unit 36, and the detailed information inference unit 38. For example, specific intention information denoted by “User intends to drink water” is transferred to only the intention inference unit 34, such that it may be used for inferring a user's intention.

The operation decision unit 30 may include a circumstance inference unit 32 to infer circumstance information associated with the user 100 and a variation in a peripheral environment of the user 100, an intention inference unit 34 to infer the intention of the user 100, a task inference unit 36 to infer task content to be performed by the robot 1, and a detailed information inference unit 38 to infer detailed task information. All the inference units 32, 34, 36, and 38 may perform such inference operations on the basis of information transferred from the first recognition unit 21, compare the inferred result with the information transferred from the second recognition unit 22, and determine the actual inference result.

The circumstance inference unit 32 infers a current circumstance (i.e., a circumstance of a time point t) from information transferred from the recognition unit 20, a circumstance of a previous time point (t−Δx) prior to the circumstance inference time point (t), an intention of the user 100, and detailed task information.

The intention inference unit 34 infers the user's intention from the information transferred from the first recognition unit 21 on the basis of the inferred circumstance information. There are a variety of examples indicating the user's intention, for example, “User intends to drink water”, “User intends to go to bed”, “User intends to go out”, “User intends to have something to eat”, etc.

The task inference unit 36 infers task content from information transferred from the first recognition unit 21′ on the basis of the inferred intention result.

The detailed information inference unit 38 infers detailed task information from information transferred from the first recognition unit 21 on the basis of the task content inference result. The detailed task information may be a position of the user 100, a variation in kitchen utensils, the opening or closing of a refrigerator door, a variation in foodstuffs stored in a refrigerator, or the like. For example, in order to command the robot to move a particular article to a certain place, information is needed about the place where the particular article is arranged, so that the above information may be used as detailed task information.

The behavior execution unit 40 operates the robot 1 in response to the robot l′s task operation decided by the operation decision unit 30, so that it provides the user 100 with a service.

Operations of the behavior decision model of the robot 1 will hereinafter be described with reference to the following embodiments.

For example, if the user 100 inputs circumstance information “User 100 is thirsty” to the robot 1 of an initial status via a passive sensing unit such as a user interface (i.e., if information initially enters the robot), in a first stage, the circumstance inference unit 32 receives information entered via weather/time/temperature/humidity sensors, such that it may firstly infer a circumstance indicating “User 100 is moving” on the basis of the received information. The circumstance inference unit 32 may again infer a current circumstance “User 100 is moving” on the basis of the firstly-inferred circumstance information “User 100 is exercising” and the above information “User 100 is thirsty” entered via the second recognition unit 22. Needless to say, based on the information “User is thirsty” entered via the second recognition unit 22, the inference may be changed to another interference corresponding to a circumstance “User 100 is eating now”. As an example, a status “User is eating” is inferred from an event “User is thirsty” according to probability distribution, such that the firstly-inferred circumstance “User is moving” may be changed to another circumstance “User is eating”.

In this case, “circumstance inference” indicates a process of inferring or reasoning a status of the environment or the user 100 on the basis of the observation result acquired through the event or data. The circumstance inferred from a certain event may be stochastic, and may be calculated from probability distribution of interest statuses based on the consideration of data and event.

In a second stage, the intention inference unit 34 may infer the user's intention “User intends to drink water” from the circumstance “User is moving” and the information transferred from the first recognition unit 21.

In a third stage, the task inference unit 36 may infer the task content “Water is delivered to user 100 from the inferred intention (i.e., User intends to drink water) and the information transferred from the first recognition unit 21.

In a fourth stage, the detailed information inference unit 38 may infer detailed task information (i.e., user's position, refrigerator's position, the opening or closing of a refrigerator door, etc.) from the inferred task content (i.e., water is delivered to user) and the information transferred from the first recognition unit 21.

In a fifth stage, the robot 1 has the intention indicating “User is moving” and “User intends to drink water”, and it brings water to the user 100 on the basis of the task content “water is delivered to user” and detailed information (i.e., user's position, refrigerator's position, the opening or closing of a refrigerator door, etc.).

If the user 100 enters task content information “Bring User Receptacle” via a passive sensing unit such as a user interface after the robot 1 has been operated, in a first stage, the circumstance inference unit 32 infers a current circumstance (i.e., a circumstance of a time point t) from information entered via the first recognition unit 21 (i.e., information entered via weather/time/temperature/humidity sensors), a circumstance of a previous time point (t−Δx) prior to the circumstance inference time point (t), an intention of the user 100, a task content and detailed task information. In more detail, the circumstance of the previous time point (t−Δx) prior to the circumstance inference time point (t) indicates that the user 100 is moving, the user's intention indicates that the user 100 intends to drink water, the task content indicates “Bring User Water”, and detailed task information is the user's position, refrigerator's position, the opening or closing of the refrigerator door, etc. Accordingly, based on weather/time/temperature/humidity information entered via the first recognition unit 21, a circumstance of a previous time point (t−Δx) prior to the circumstance inference time point (t), the user's intention, task content, detailed task information, a current circumstance “User is moving” may be inferred.

In a second stage, the intention inference unit 34 may infer the user's intention “User intends to drink water” from the inferred circumstance “User is moving” and the information entered via the first recognition unit 21 (i.e., information entered via weather/time/temperature/humidity sensors).

In a third stage, the task inference unit 36 may firstly infer a task content “Bring User Water” from the inferred intention “user intends to drink water” and information entered via the first recognition unit 21 (i.e., information entered via weather/time/temperature/humidity sensors). The task inference unit 36 compares information “Bring User Receptacle” entered via the second recognition unit 22 with the firstly-inferred information “Bring User Water”, and determines the actual inference result indicating that the task content is “Bring User Receptacle”. In this case, when designing the behavior decision model of the robot 1, it is able to determine a weight by which information entered via the second recognition unit 22 has priority over the firstly-inferred information. However, when determining the priority by comparison between the firstly-inferred information and the information entered via the second recognition unit 22, it may be possible to determine the priority at random as necessary.

In a fourth stage, the detailed information inference unit 38 may infer detailed task information (i.e., user's position, kitchen's position, and receptacle's position) from the inferred task content “Bring User Receptacle” and information transferred from the first recognition unit 21.

In a fifth stage, the robot 1 has the intention indicating “User is moving” and “User intends to drink water”, and it brings water to the user 100 on the basis of the task content “water is delivered to user” and detailed information (i.e., user's position, kitchen's position, receptacle's position, etc.).

In the meantime, as shown in the above-mentioned example, the first recognition unit 21 converts raw information into data, and transmits the converted data to the circumstance inference unit 32, the intention inference unit 34, the task inference unit 36, and the detailed information inference unit 38. The second recognition unit 22 converts specific information into data, and transmits the converted data to only a corresponding one among the inference units 32, 34, 36, and 38.

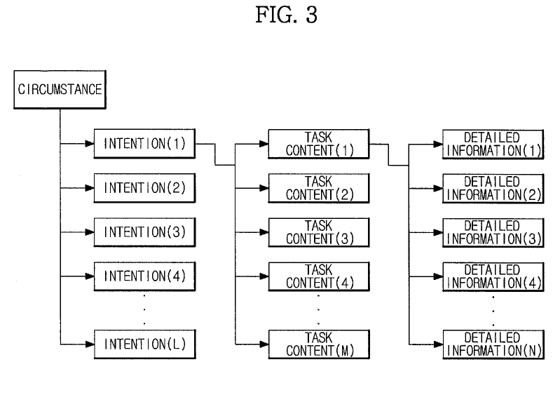

FIG. 3 depicts a scenario for a robot behavior decision model according to example embodiments.

Referring to FIG. 3, the scenario of the behavior decision model of the robot 1 may include L number of user's intentions in a single circumstance, M number of task contents may be included in the user's intention, and N number of detailed information may be included in a single task content.

Accordingly, a scenario tree in which four scenario bases (Circumstance+Intention+Task Content+Detailed Information) are used as nodes may be formed, and detailed scenarios are combined such that a variety of scenarios can be configured.

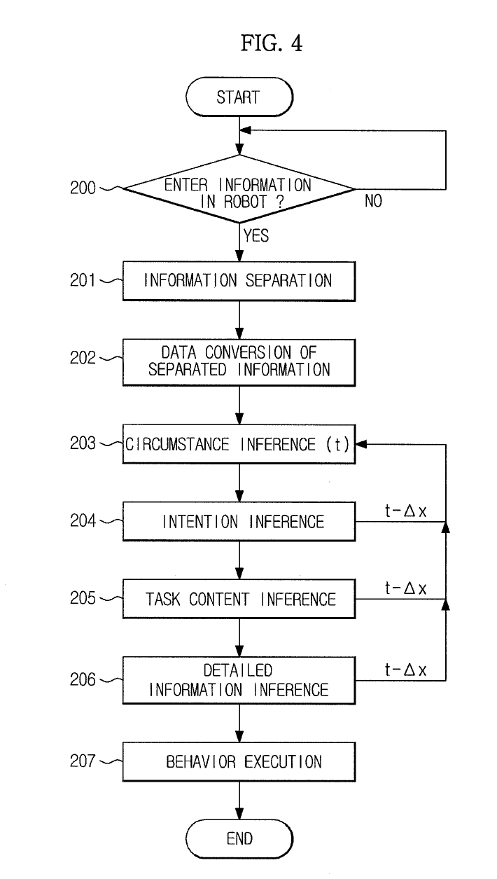

FIG. 4 is a flowchart illustrating a robot behavior decision model according to example embodiments.

Referring to FIG. 4, the robot 1 determines whether raw information is entered via the active sensing unit such as a sensor, or specific information is entered via the passive sensing unit such as a user interface at operation 200.

If it is determined that the raw information or specific information has been input at operation 200, the information separation unit 10 separates the raw information and the specific information from each other at operation 201.

Meanwhile, information may be entered via a network. Among total information entered via the network, information entered by the user 100 may be classified as specific information, and information stored in a database may be classified as raw information. This is one method of entering information in the robot 1. Information entered via a plurality of methods may be classified into two types of information, i.e., raw information and specific information.

The first recognition unit 21 receives raw information entered via the active sensing unit such as a sensor, and converts the received raw information into data recognizable by the robot 1 at operation 202. The second recognition unit 22 receives specific information entered via the passive sensing unit such as a user interface, and converts the received specific information into data recognizable by the robot 1 at operation 202.

The circumstance inference unit 32 firstly infers a current circumstance from the raw information received from the first recognition unit 21 and a circumstance of a previous time point (t−Δx) of the circumstance inference time point (t), user's intention, task content, and detailed task information. The circumstance inference unit 32 compares the firstly-inferred circumstance with the specific information received from the second recognition unit 22, so that it determines the actual inference result (i.e., second inference). The second recognition unit 22 converts the specific information into other data, and transmits the converted data to only a corresponding one among the inference units 32, 34, 36, and 38. For example, if it is assumed that the specific information indicates a command “Bring User Water”, this command is relevant to task content, and that the specific information is transferred to only the task inference unit 36. Meanwhile, the above-mentioned fact that the command “Bring User Water” is relevant to the task content is pre-stored in a database (not shown). Accordingly, if it is assumed that specific information indicating the command “Bring User Water” is stored as intention-associated information in the database, this specific information is transferred to the intention inference unit 34 at operation 203.

The intention inference unit 34 firstly infers the user's intention from the information transferred from the first recognition unit 21 on the basis of the inferred circumstance information, and compares the firstly-inferred intention with specific information transferred from the second recognition unit 22 to determine the actual inference result at operation 204.

The task inference unit 36 infers the task content from the inferred intention and information transferred from the first recognition unit 21, and compares the firstly-inferred task content with specific information transferred from the second recognition unit 22, to determine the actual inference result at operation 205.

The detailed information inference unit 38 infers detailed task information from the inferred task content and the information transferred from the first recognition unit 21, and compares the firstly-inferred detailed task information with specific information transferred from the second recognition unit 22, to determine the actual inference result at operation 206.

On the other hand, the above-mentioned operations of determining the actual inference result by comparing the firstly-inferred circumstance/intention/task content/detailed-information with specific information may be stochastic, and may be calculated from probability distribution of interest statuses based on the consideration of both data and events. In addition, a high weight may be assigned to either of the firstly-inferred circumstance/intention/task-content/detailed-information or specific information, such that the actually-inferred circumstance/intention/task-content/detailed information may be determined. The operation of determining the actual inference result by comparing the actually-inferred circumstance/intention/task-content/detailed-information with the specific information is carried out when the specific information is transferred to the corresponding inference units 32, 34, 36, and 38 via the second recognition unit 22. If no specific information is transferred to the corresponding inference units 32, 34, 36, and 38, the firstly-inferred circumstance/intention/task-content/detailed-information may be determined to be circumstance/intention/task-content/detailed-information of an inference time point.

Next, the behavior execution unit 40 operates the robot 1 in response to the inferred task content and detailed task information of the robot 1, such that it provides the user 100 with a service. The robot 1 carries out the task in response to the inferred circumstance and the user's intention at operation 207.

The above-described embodiments may be recorded in computer-readable media including program instructions to implement various operations embodied by a computer. The media may also include, alone or in combination with the program instructions, data files, data structures, and the like. Examples of computer-readable media (computer-readable storage devices) include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. A robot, comprising:
an information separation unit to separate raw information and specific information; and
an operation decision unit to decide a task operation of a robot by inferring a circumstance, a user's intention, task content, and detailed task information from the separated information.

2. The robot according to claim 1, wherein the operation decision unit receives the raw information, and converts the received raw information into data recognizable by the robot.

3. The robot according to claim 1, wherein the operation decision unit receives the specific information, and converts the received specific information into data recognizable by the robot.

4. The robot according to claim 1, wherein the operation decision unit includes a circumstance inference unit which firstly infers the circumstance from the raw information and a circumstance, a user's intention, task content, and detailed task information of a time point earlier than that of the circumstance inference.

5. The robot according to claim 4, wherein the circumstance inference unit compares the firstly-inferred circumstance information with the specific information, and thus secondly infers the circumstance.

6. The robot according to claim 1, wherein the operation decision unit includes an intention inference unit which firstly infers the user's intention from the raw information and the inferred circumstance information.

7. The robot according to claim 6, wherein the intention inference unit secondly infers the user's intention by comparing the firstly-inferred user's intention information with the specific information.

8. The robot according to claim 1, wherein the operation decision unit includes a task inference unit which firstly infers the task content from the raw information and the inferred intention information.

9. The robot according to claim 8, wherein the task inference unit secondly infers the task content by comparing the firstly-inferred task content information with the specific information.

10. The robot according to claim 1, wherein the operation decision unit includes a detailed information inference unit which firstly infers the detailed task information from not only the raw information but also the inferred task content information.

11. The robot according to claim 10, wherein the detailed information inference unit secondly infers the detailed task information by comparing the inferred detailed information with the specific information.

12. The robot according to claim 1, further comprising:
a behavior execution unit to operate the robot in response to the decided task operation of the robot.

13. A method of controlling a robot, comprising:
separating, using a processor, raw information and specific information; and
deciding, using the processor, a task operation of a robot by inferring a circumstance, a user's intention, task content, and detailed task information from the separated information.

14. The method according to claim 13, wherein the deciding of the task operation of the robot includes deciding the robot's task operation by inferring the circumstance from the raw information and a circumstance, a user's intention, task content, and detailed task information of a time point earlier than that of the circumstance inference.

15. The method according to claim 14, further comprising:
re-inferring the circumstance by comparing the inferred circumstance information with the specific information.

16. The method according to claim 13, wherein the deciding of the task operation of the robot includes deciding the robot task operation by inferring the user's intention from the inferred circumstance information and the raw information.

17. The method according to claim 16, further comprising:
re-inferring the user's intention by comparing the inferred user's intention information with the specific information.

18. The method according to claim 13, wherein the deciding of the task operation of the robot includes deciding the robot task operation by inferring the task content from the inferred user's intention information and the raw information.

19. The method according to claim 18, further comprising:
re-inferring the task content by comparing the inferred task content information with the specific information.

20. The method according to claim 13, wherein the deciding of the task operation of the robot includes deciding the robot task operation by inferring the detailed task information from the inferred task content information and the raw information.

21. The method according to claim 20, further comprising:
re-inferring the detailed task information by comparing the inferred detailed task information with the specific information.
